(19) United States
(12) Patent Application Publication
(10) Pub. No.: US 2016/0346740 A1
(43) Pub. Date: Dec. 1, 2016

(54) ULTRA-SELECTIVE CARBON MOLECULAR SIEVE MEMBRANES AND METHODS OF MAKING

(71) Applicant: Georgia Tech Research Corporation, Atlanta, GA (US)

(72) Inventors: William John Koros, Atlanta, GA (US); Chen Zhang, Atlanta, GA (US)

(21) Appl. No.: 15/170,529

(22) Filed: Jun. 1, 2016

Related U.S. Application Data
(60) Provisional application No. 62/168,982, filed on Jun. 1, 2015.
(60) Provisional application No. 62/169,218, filed on Jun. 1, 2015.

(51) Int. Cl. B01D 71/02; B01D 53/22; B01D 67/00

(52) U.S. Cl. CPC B01D 71/021; B01D 67/0083; B01D 53/225; B01D 53/228; B01D 2053/221; B01D 2323/08; B01D 2317/00

(57) ABSTRACT

Embodiments of the present disclosure are directed to a process for making a carbon molecular sieve membrane having a desired permselectivity between a first gas species and a second gas species, in which the second gas species has a larger kinetic diameter than the first gas species. The process comprises providing a polymer precursor and pyrolyzing the polymer precursor at a pyrolysis temperature that is effective to selectively reduce the sorption coefficient of the second gas species, thereby increasing the permselectivity of the resulting carbon molecular sieve membrane.

The present application claims priority under 35 U.S.C. §119(e) to U.S. Provisional Application Nos. 62/168,982 and 62/169,218, filed on Jun. 1, 2015, the entire contents of which are incorporated herein by reference.

### BACKGROUND OF THE INVENTION

Carbon molecular sieve (CMS) membranes have received increasing attention in the past years for advanced gas separations. CMS membranes are formed by controlled pyrolysis of polymer precursors and pores are formed by packing imperfections of high disordered and disoriented sp²-hybridized graphene-like sheets. CMS membranes can be formed into asymmetric hollow fibers, by controlled pyrolysis of polymeric precursor hollow fiber membranes, and are capable of delivering simultaneously attractive productivity and separation efficiency without compromising scalability. Micropores (7 Å<d<20 Å) provide the majority of surface area for sorption and are responsible for the membrane's high permeability. On the other hand, ultramicropores (d<7 Å) connecting micropores control diffusivity and consequently diffusion selectivity. It should be noted that unlike crystalline molecular sieves (e.g. zeolites and MOFs), CMS is amorphous and its ultramicropore size is not uniform through the membrane. A more detailed description of CMS bimodal pore size distribution can be found elsewhere in the art.

Pyrolysis temperature is a key factor controlling CMS membrane's ultramicropore size distribution and therefore, permeation properties. In general, more densely packed sp²-hybridized graphene-like sheets with lower permeability and higher selectivity are obtained with increasing pyrolysis temperature. For example, previous studies showed that CO₂/CH₄ selectivity of Matrimid®-derived CMS membranes was enhanced by 200% as pyrolysis temperature increased from 650° C. to 800° C. However, formation of CMS membranes at pyrolysis temperatures above 800° C. has been rarely reported, at least in part due to challenges involved with processing brittle CMS dense films at high pyrolysis temperature. In the current disclosure, we discover that this challenge can be overcome by using special dense-walled CMS hollow fibers with excellent mechanical properties. Accordingly, the present disclosure describes the formation of CMS hollow fiber membranes at pyrolysis temperature up to 900° C.

### SUMMARY OF THE INVENTION

Embodiments of the present disclosure are directed to a process for making a carbon molecular sieve membrane having a desired permselectivity between a first gas species and a second gas species, in which the second gas species has a larger kinetic diameter than the first gas species. The process comprises providing a polymer precursor and pyrolyzing the polymer precursor at a pyrolysis temperature that is effective to selectively reduce the sorption coefficient of the second gas species, thereby increasing the permselectivity of the resulting carbon molecular sieve membrane. By selectively reducing the sorption coefficient of the second gas species, it is meant that the sorption coefficient of the second gas species is reduced to a significantly greater extent than is the sorption coefficient of the first gas species. In some instances, the sorption coefficient of the first gas species may be minimally reduced or substantially unchanged. In other instances, the sorption coefficient of the first gas species may be reduced by for example, 50% or more, whereas the sorption coefficient of the second gas species may be reduced for example by at least 60%, at least 70%, or at least 80%.

In some embodiments, the second gas species may be CH₄ and the first gas species may be at least one of H₂, N₂, and/or CO₂. In other embodiments, the first gas species may be CO₂ and the second gas species may be N₂. In other embodiments, the first gas species may be O₂ and the second gas species may be N₂. In some embodiments, the pyrolysis temperature may be greater than 800° C., alternatively greater than 850° C., alternatively greater than 875° C., alternatively greater than 900° C. In some embodiments, the polymer precursor may comprise a polymeric fiber, such as an asymmetric hollow polymer fiber, or a polymeric film. In some embodiments, the polymer precursor may comprise a polyimide.

Embodiments of the present disclosure are directed to a process for making a carbon molecular sieve membrane having ultra-selectivity between a first gas species and a second gas species. The process comprises providing a polymer precursor and pyrolyzing the polymer precursor at a pyrolysis temperature that is effective to increase the sorption selectivity of the resulting carbon molecular sieve membrane while substantially maintaining the diffusion selectivity of the resulting carbon molecular sieve membrane, thereby providing a carbon molecular sieve membrane having ultra-selectivity between the first gas species and the second gas species. The pyrolyzing may also further be effective to increase the diffusion selectivity of the resulting carbon molecular sieve membrane.

In some embodiments, the second gas species may be CH₄ and the first gas species may be at least one of H₂, N₂, and/or CO₂. In other embodiments, the first gas species may be CO₂ and the second gas species may be N₂. In other embodiments, the first gas species may be O₂ and the second gas species may be N₂. In some embodiments, the pyrolysis temperature may be greater than 800° C., alternatively greater than 850° C., alternatively greater than 875° C., alternatively greater than 900° C. In some embodiments, the polymer precursor may comprise a polymeric fiber, such as an asymmetric hollow polymer fiber, or a polymeric film. In some embodiments, the polymer precursor may comprise a polyimide.

Embodiments of the present disclosure are directed to a process for separating at least a first gas species and a second gas species. The process comprises providing a carbon molecular sieve membrane produced by any of the processes described herein and flowing a mixture of at least the first gas species and the second gas species through the membrane to produce (i) a retentate stream having a reduced concentration of the first gas species, and (ii) a permeate stream having an increased concentration of the first gas species. For example, in some embodiments, the process may be utilized for separating non-hydrocarbon components from a natural gas stream by contacting a natural gas stream with a carbon molecular sieve membrane produced by any of the processes described herein to produce (i) a retentate stream having a reduced concentration of non-hydrocarbon components, and (ii) a permeate stream having an increased concentration of non-hydrocarbon components. The non-hydrocarbon components may comprise H₂, N₂, CO₂, H₂S, or mixtures thereof. In other embodiments, the process may be utilized for separating CO₂ and N₂.

Embodiments of the present disclosure are directed to a carbon molecular sieve module comprising a sealable enclosure, the enclosure having: (a) a plurality of carbon molecular sieve membranes contained therein, at least one of the carbon molecular sieve membranes produced according to the presently disclosed process; (b) an inlet for introducing a feed stream comprising at least a first gas species and a second gas species; (c) a first outlet for permitting egress of a permeate gas stream; and (d) a second outlet for permitting egress of a retentate gas stream.

Embodiments of the present disclosure are directed to a mixed-matrix carbon molecular sieve membrane having a permselectivity between a first gas species and a second gas species, the second gas species having a larger kinetic diameter than the first gas species. The mixed-matrix carbon molecular sieve comprises a matrix material and a sieve material, wherein the sieve material comprises a carbon molecular sieve material having micropores that are sized so as to exclude sorption of the second gas species; and the matrix material comprises a carbon molecular sieve material having micropores that are sized so as to provide for sorption of the second gas species. In some embodiments, the second gas species may be CH₄, N₂, or a combination thereof. Moreover, in some embodiments, the mixed-matrix carbon molecular sieve membrane may have substantially no sieve-matrix interface.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1A is an SEM image of an embodiment of a monolithic Matrimid® precursor hollow fiber membrane prepared according to the present disclosure.

FIG. 1B is an SEM image of an embodiment of a dense-walled CMS hollow fiber membrane prepared according to the present disclosure.

FIG. 2 is a graph showing the CO₂/CH₄ separation performance of Matrimid®-derived CMS pyrolyzed at 750-900° C.

FIG. 3 is a graph showing the N₂/CH₄ separation performance of Matrimid®-derived CMS pyrolyzed at 750-900° C.

FIG. 4 is a graph showing the H₂/CH₄ separation performance of Matrimid®-derived CMS pyrolyzed at 750-900° C.

FIG. 5 is a graph showing the O₂/N₂ separation performance of Matrimid®-derived CMS pyrolyzed at 750-900° C.

FIG. 6A is a graph showing the pyrolysis temperature dependence of permeability for CO₂/CH₄.

FIG. 6B is a graph showing the pyrolysis temperature dependence of diffusivity for CO₂/CH₄.

FIG. 6C is a graph showing the pyrolysis temperature dependence of sorption coefficient for CO₂/CH₄.

FIG. 7A is a graph showing the pyrolysis temperature dependence of permeability for N₂/CH₄.

FIG. 7B is a graph showing the pyrolysis temperature dependence of diffusivity for N₂/CH₄.

FIG. 7C is a graph showing the pyrolysis temperature dependence of sorption coefficient for N₂/CH₄.

FIG. 8A is a graph showing the pyrolysis temperature dependence of permeability for O₂/N₂.

FIG. 8B is a graph showing the pyrolysis temperature dependence of diffusivity for O₂/N₂.

FIG. 8C is a graph showing the pyrolysis temperature dependence of sorption coefficient for O₂/N₂.

FIG. 9 is a graph showing the pyrolysis temperature dependence of CO₂/CH₄ diffusion selectivity and sorption selectivity.

FIG. 10 is a graph showing the pyrolysis temperature dependence of N₂/CH₄ diffusion selectivity and sorption selectivity.

FIG. 11 is a graph showing the pyrolysis temperature dependence of O₂/N₂ diffusion selectivity and sorption selectivity.

FIG. 12 is an illustration showing the structural evolution of CMS micropores as pyrolysis temperature increases from 750 to 900° C.

FIG. 13 is an illustration showing hypothetical diffusion pathways of CO₂ and CH₄ in ultra-selective CMS membranes.

### DETAILED DESCRIPTION OF THE INVENTION

The present invention will now be described more fully hereinafter with reference to the accompanying drawings, in which one or more embodiments of the invention are shown. This invention may, however, be embodied in many different forms and should not be construed as limited to the embodiments described herein. Rather, these embodiments are examples of the invention, which has the full scope indicated by the language of the claims.

This present disclosure reveals a surprising and unexpected method to increase sorption selectivity of carbon molecular sieve (CMS) membranes by pyrolysis above certain temperatures. With increased sorption selectivity, ultra-selective CMS membranes with significantly increased permselectivity are formed. Such ultra-selective CMS membranes are potentially able to open the way for membrane-based separations to solve more challenging and unconventional problems such as purification of highly CO₂/N₂/H₂S-contaminated natural gas and/or the separation of CO₂ and N₂ gas mixtures.

An example is given by Matrimid®, which is a commercially available polyimide precursor extensively studied for gas separations. To deconvolute the contributions of diffusion and sorption, special dense-walled CMS hollow fibers were formed by pyrolyzing precursor Matrimid hollow fibers at 750-900° C. The membranes were characterized with hydrogen, oxygen, carbon dioxide, nitrogen, and methane single-gas permeation as well as carbon dioxide/methane mixed-gas permeation. Results show that increasing pyrolysis temperature from 750 to 900° C. significantly increases permselectivities of hydrogen/methane, carbon dioxide/methane, nitrogen/methane, and oxygen/nitrogen. Surprisingly, analysis of permeation data indicates that increasing pyrolysis temperature remarkably reduces methane sorption coefficients, and consequently increases sorption selectivity of hydrogen, nitrogen, and carbon dioxide over methane. Although not bound by theory, we believe that the reduced methane sorption coefficient was due to reduced percentage of micropores accessible for methane diffusion/sorption as the ultramicropores are refined at increased pyrolysis temperature. In fact, by creating these “methane-excluding” and “nitrogen-excluding” micropores/domains inside the CMS network, we have invented a new type of membrane—namely a CMS/CMS' mixed-matrix membrane. While the example is given by polyimide-derived CMS, a person of ordinary skill in the art would understand that these discoveries could be extended to other polymer precursor materials for a wider spectrum of gas/vapor/liquid separation applications that are not limited to those specifically described herein.

Permeation of gas molecules through dense membranes follows the solution-diffusion mechanism. Gas molecules dissolve at the high concentration (upstream) side of the membrane and diffuse through the membrane along a concentration gradient to the low concentration (downstream) side of the membrane. Permeability is commonly used to characterize productivity of a membrane. The permeability of gas A is defined as the steady-state flux (N_{A}), normalized by trans-membrane partial pressure difference (Δp_{A}) and thickness of effective membrane selective layer (l):

$${P}_{A} = \frac{{N}_{A} \cdot l}{Δ {p}_{A}} \qquad ( 1 )$$

Permeability is traditionally given in the unit of Barrer:

$$1 Barrer = 1 {10}^{- 10} \frac{{cm}^{3} ( STP ) \cdot cm}{{cm}^{2} \cdot s \cdot cmHg}$$

For asymmetric hollow fibers, thickness of effective membrane selective layer (skin layer) usually cannot be reliably determined. Therefore membrane productivity is described by permeance, which is simply the trans-membrane partial pressure normalized flux:

$$( \frac{{P}_{A}}{l} ) = \frac{{N}_{A}}{Δ {p}_{A}} \qquad ( 2 )$$

“Gas permeation unit” or GPU is usually used as the unit of permeance, which is defined as:

$$1 GPU = {10}^{- 6} \frac{{cm}^{3} ( STP )}{{cm}^{2} \cdot s \cdot cmHg}$$

Ideal selectivity and separation factor are usually used to characterize the efficiency of a membrane to separate a faster-permeating species A from a slower-permeating species B. For single gas permeation, the ideal selectivity of the membrane is defined as the ratio of single gas permeabilities or permeances:

$${α}_{A \text{/} B} = \frac{{P}_{A}}{{P}_{B}} = \frac{( {P}_{A} \text{/} l )}{( {P}_{B} \text{/} l )} \qquad ( 3 )$$

When a gas mixture permeates through a membrane, the separation factor is written as:

$${α}_{AB} = \frac{( {y}_{A} \text{/} {y}_{B} )}{( {x}_{A} \text{/} {x}_{B} )} \qquad ( 4 )$$

Where y and x are mole fractions in the downstream and upstream side of the membrane. Permeability can be decomposed into the product of a kinetic factor (diffusivity) and a thermodynamic factor (sorption coefficient):

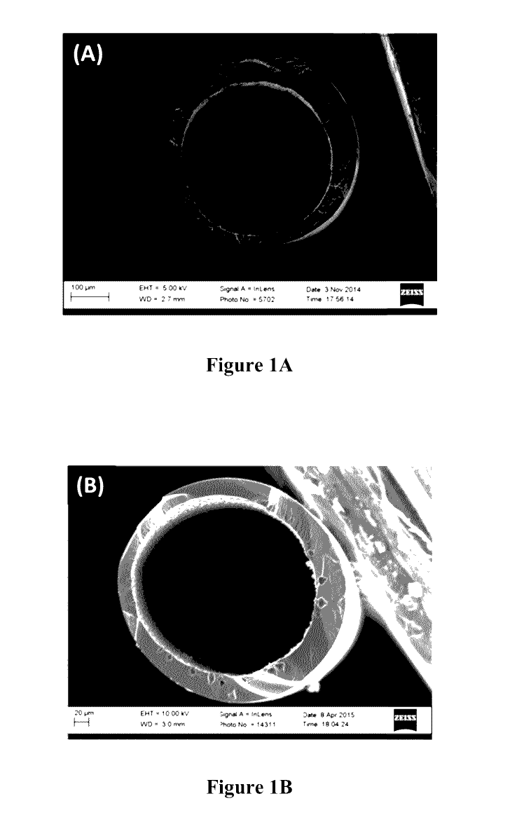

P_{A}=D_{A}×S_{A} (5)

in which D is diffusivity (cm²/s) and S is sorption coefficient (cc[STP]/cc·cmHg). Based on equation 3 and 5, ideal selectivity can be written as the product of diffusion selectivity and sorption selectivity:

$${α}_{AB} = {α}_{D} {α}_{S} = ( \frac{{D}_{A}}{{D}_{B}} ) ( \frac{{S}_{A}}{{S}_{B}} ) \qquad ( 6 )$$

in which α_{D} is diffusion selectivity and αₛ is sorption selectivity. Diffusivity can be estimated using the time lag method:

$$D = \frac{{l}^{2}}{6 θ} \qquad ( 7 )$$

in which l is thickness of the separation layer and θ is the permeation time lag as shown in FIG. 1. Sorption in CMS and other porous materials can be described by the Langmuir equation that assumes homogeneous surface and negligible interactions between sorbing molecules:

$$C = \frac{{C}_{HA}^{′} {b}_{A} {p}_{A}}{1 + {b}_{A} {p}_{A}} \qquad ( 8 )$$

in which C is sorption capacity (cc[STP]/cc cmHg) and p_{A} (psia) is gas phase equilibrium pressure. C′_{HA} is saturation capacity (cc[STP]/cc cmHg) and is usually correlated with surface area available for sorption, and b_{A} (psia⁻¹) is the affinity constant and is usually governed by the strength of physical and/or chemical interactions between sorbed molecules and sorbent surface.

The polymer precursor fiber may comprise any polymeric material that, after undergoing pyrolysis, produces a CMS membrane that permits passage of the desired gases to be separated and in which at least one of the desired gases permeates through the CMS fiber at different diffusion rate than other components. The polyimides are preferred polymers precursor materials. Suitable polyimides include, for example, Ultem® 1000, Matrimid® 5218, 6FDA/BPDA-DAM, 6FDA-6FpDA, and 6FDA-IPDA.

Examples of other suitable precursor polymers include polysulfones; poly(styrenes), including styrene-containing copolymers such as acrylonitrilestyrene copolymers, styrene-butadiene copolymers and styrene-vinylbenzylhalide copolymers: polycarbonates; cellulosic polymers, such as cellulose acetate-butyrate, cellulose propionate, ethyl cellulose, methyl cellulose, nitrocellulose, etc.; poly-amides and polyimides, including aryl polyamides and aryl polyimides; polyethers; polyetherimides; polyetherketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polypyrrolones; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acyl groups and the like.

Preferably, the polymer is a rigid, glassy polymer at room temperature as opposed to a rubbery polymer or a flexible glassy polymer. Glassy polymers are differentiated from rubbery polymers by the rate of segmental movement of polymer chains. Polymers in the glassy state do not have the rapid molecular motions that permit rubbery polymers their liquid-like nature and their ability to adjust segmental configurations rapidly over large distances (>0.5 nm). Glassy polymers exist in a non-equilibrium state with entangled molecular chains with immobile molecular backbones in frozen conformations. The glass transition temperature (T_{g}) is the dividing point between the rubbery or glassy state. Above the T_{g}, the polymer exists in the rubbery state; below the T_{g}, the polymer exists in the glassy state. Generally, glassy polymers provide a selective environment for gas diffusion and are favored for gas separation applications. Rigid, glassy polymers describe polymers with rigid polymer chain backbones that have limited intramolecular rotational mobility and are often characterized by having high glass transition temperatures. Preferred polymer precursors have a glass transition temperature of at least 200° C. Such polymers are well known in the art and include polyimides, polysulfones and cellulosic polymers.

Matrimid® 5218 polyimide (T_{g}=305−310° C.) was used as the precursor materials in the examples described below. The chemical structure of Matrimid® 5218 is shown below:

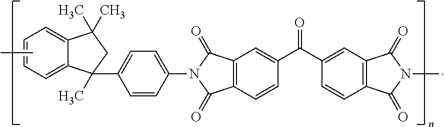

Monolithic Matrimid® precursor hollow fiber membranes were spun using the “dry-jet/wet-quench” technique. Spinning dope composition and spinning parameters can be found in the literature, such as at Clausi, D. T.; Koros, W. J., Formation of defect free polyimide hollow fiber membranes for gas separations, Journal of Membrane Science 2000, 167 (1), 79-89, the entirety of which is incorporated herein by reference. It should be noted that a change was made to the dope/bore fluid flow rate ratio. To enable faster and more convenient permeation measurements using dense-walled CMS fiber, the dope/bore fluid flow rate ratio was intentionally reduced to create thin-walled precursor fiber. Contrary to the usual ratio of three (e.g. 180 cc/hr as dope flowrate and 60 cc/hr as bore fluid flow rate), a ratio of one was used (120 cc/hr as dope flow rate and 120 cc/hr as bore fluid flow rate). A representative SEM image of the thin-walled (wall thickness˜49 μm) precursor hollow fiber is shown in FIG. 1(A).

CMS hollow fiber membranes were formed by controlled pyrolysis of Matrimid precursor® hollow fiber membranes using the heating protocol below under continuous purge (200 cc/min) of ultra-high-purity (UHP) Argon.

### Heating Protocol

1) 50° C. to 250° C. (13.3° C./min)
2) 250° C. to T_{final}-15 (3.85° C./min)
3) T_{final}−15 to T_{final} (0.25° C./min)
4) Thermal soak at T_{final} for 120 min
5) Cool down naturally
T_{final}=750, 800, 850, 875, and 900° C.
   Details of the pyrolysis set-up can be found in the literature, such as at Kiyono, M.; Williams, P. J.; Koros, W. J., Effect of pyrolysis atmosphere on separation performance of carbon molecular sieve membranes, Journal of Membrane Science 2010, 359 (1-2), 2-10, the entirety of which is incorporated herein by reference. Since Matrimid® is a low-T_{g} (glass transition temperature) polymer, the porous substrate of the precursor fiber would collapse due to high temperature pyrolysis. While they are undesirable for practical applications due to unattractive permeance, dense-walled CMS hollow fibers are actually ideal for characterizing the material's intrinsic permeation properties since separation layer thickness can be unambiguously determined. A representative SEM image of dense-walled (wall thickness˜32 μm) CMS hollow fiber is shown in FIG. 1(B). It should be noted that dimension (fiber outer diameter [OD], inner diameter [ID], and wall thickness) of CMS hollow fibers pyrolyzed at different temperatures were essentially identical.

Dense-walled CMS hollow fibers membranes were characterized with H₂, CO₂, O₂, N₂, and CH₄ single-gas permeation at 35° C. and 100 psia upstream pressure (vacuum downstream). Two modules (each made with 1-3 fibers) were tested for single-gas permeation at each pyrolysis temperature. Additionally, CMS fibers pyrolyzed at 750, 800, 850, and 875° C. were characterized with CO₂ (10%)/CH₄ (90%) mixed-gas permeation at 35° C. and 100 psia upstream pressure (vacuum downstream). A single module (made with 1-3 fibers) was tested for mixed-gas permeation at each pyrolysis temperature. Downstream concentrations were analyzed with a Varian-450 GC (gas chromatograph). The stage cut, which is the percentage of feed that permeates through the membrane, was kept less than 1% to avoid concentration polarization.

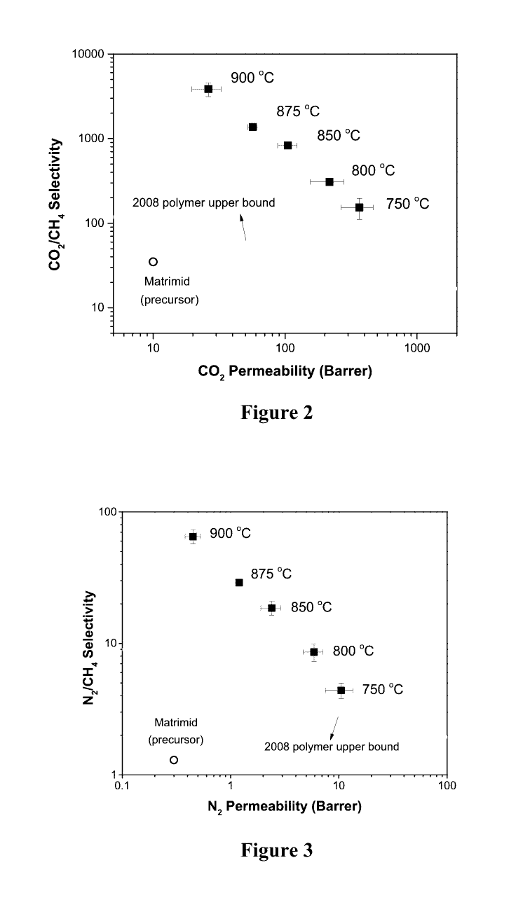

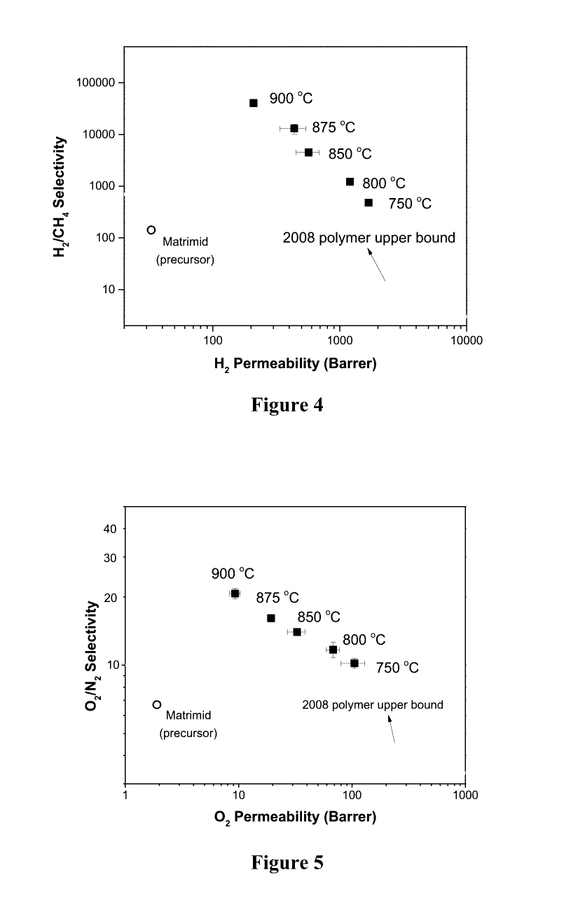

CMS hollow fiber permeation results (CO₂/CH₄, N₂/CH₄, H₂/CH₄, and O₂/N₂) are shown in FIG. 2-5. Polymer upper bound curves for each gas pair are also shown for reference. As the pyrolysis temperature increases from 750 to 900° C., selectivities were significantly increased to unprecedentedly high numbers that are well above the polymer upper bound. For CMS pyrolyzed at 900° C., the membrane displayed some of the highest ideal selectivities (α[CO₂/CH₄]=3650, α[N₂/CH₄]=63, α[H₂/CH₄]=40350, and α[O₂/N₂]=21) reported on polymer-derived membranes that separate gas mixtures based on solution-diffusion.

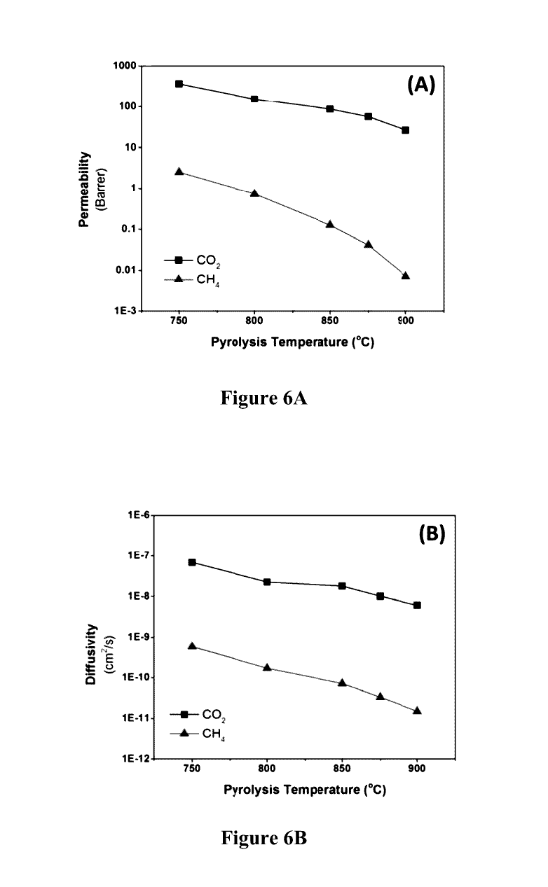

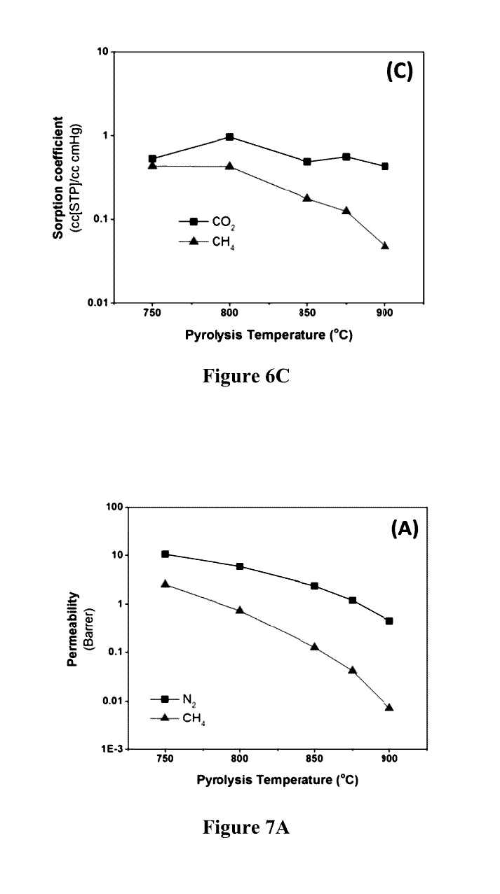

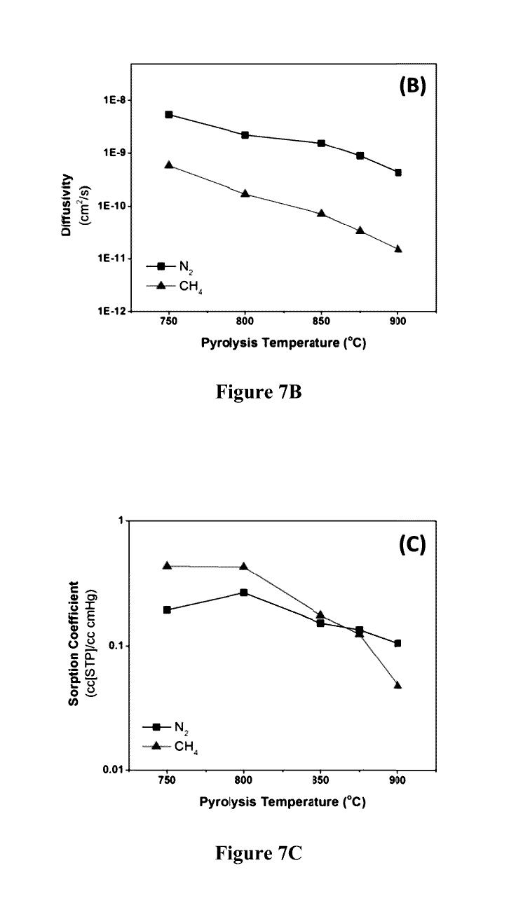

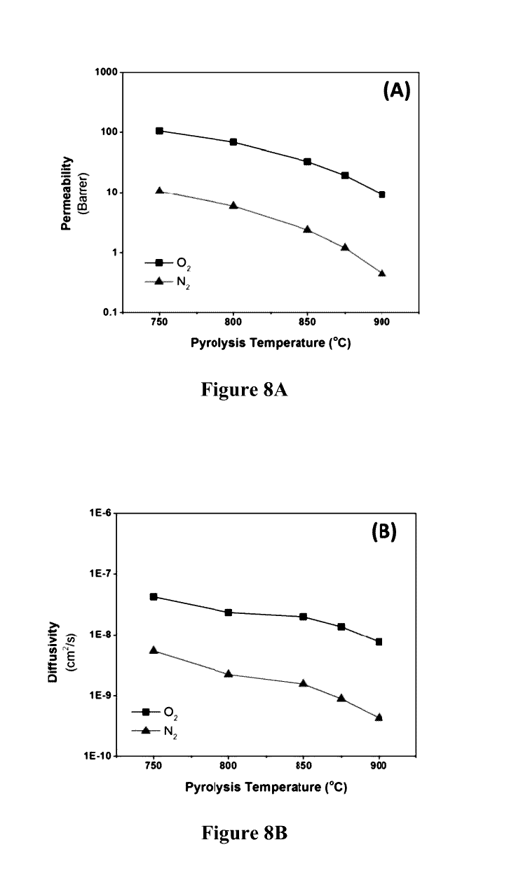

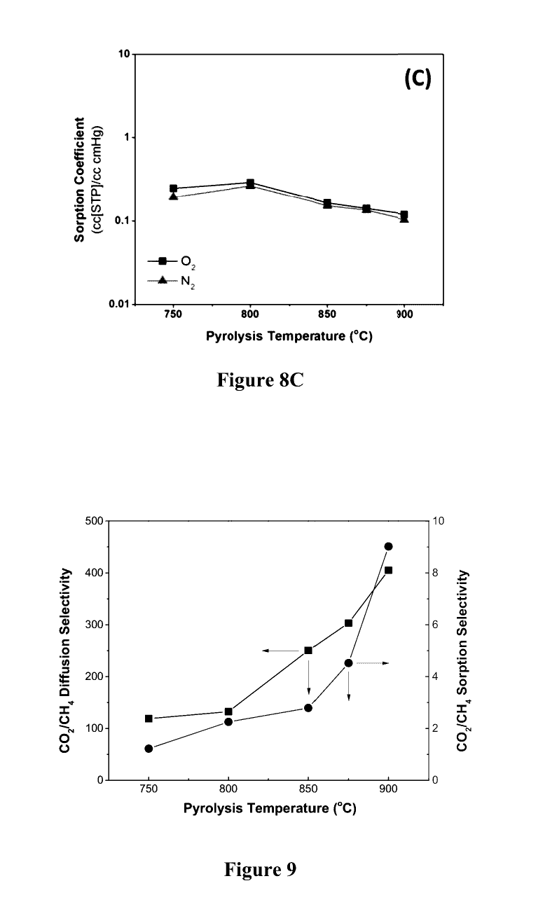

Permeability, diffusivity, and sorption coefficient data of CO₂, O₂, N₂, and CH₄ are shown in FIG. 6-8. Diffusivity data of CO₂, O₂, N₂, and CH₄ are estimated by the time-lag method (equation 7) using permeation plots. Is should be noted that diffusivity estimation was not performed for H₂ since the permeation was overly fast and it wasn't possible to reliably determine its permeation time lag. Sorption coefficient of CO₂, O₂, N₂, and CH₄ were further calculated with equation 5.

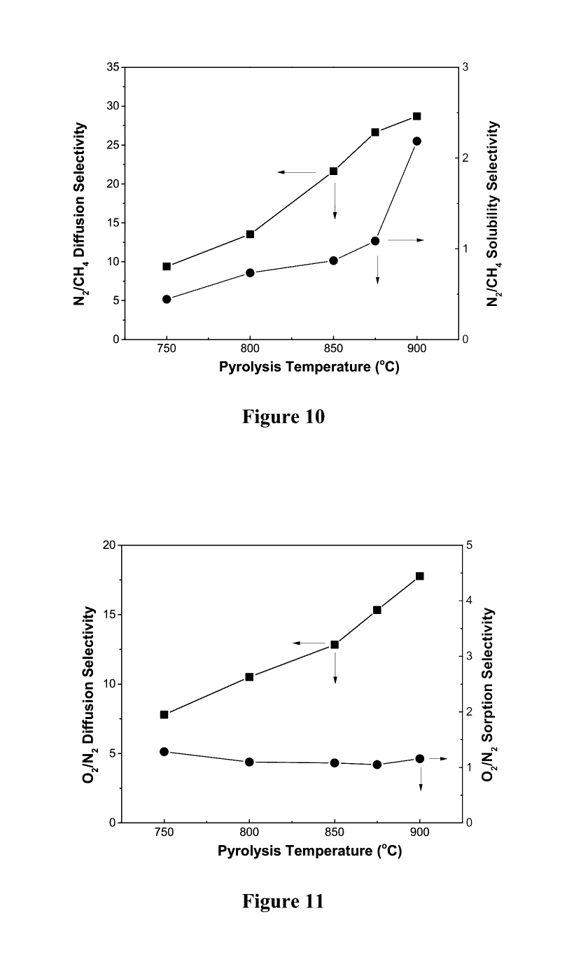

Based on diffusivity and sorption coefficient data of each component, permselectivity data of CO₂/CH₄, N₂/CH₄, and O₂/N₂ were decomposed into diffusion selectivity and sorption selectivity using equation 6 and shown in FIG. 9-11. FIG. 9 shows that increased CO₂/CH₄ selectivity was due to simultaneously increased CO₂/CH₄ diffusion selectivity and CO₂/CH₄ sorption selectivity. As pyrolysis temperature increases from 750 to 900° C., CO₂/CH₄ diffusion selectivity increases by 3.4 times from 119 to 406, while CO₂/CH₄ sorption selectivity increases by 7.4 times from 1.2 to 9. Similarly, increased N₂/CH₄ selectivity was also due to simultaneously increased N₂/CH₄ diffusion selectivity and N₂/CH₄ sorption selectivity (FIG. 10). As pyrolysis temperature increases from 750 to 900° C., N₂/CH₄ diffusivity selectivity increases by 3.1 times from 9.4 to 28.7, while N₂/CH₄ sorption selectivity increases by 5 times from 0.44 to 2.2. On the contrary, FIG. 11 suggested that increased O₂/N₂ selectivity was entirely due to increased O₂/N₂ diffusion selectivity. As pyrolysis temperature increases from 750 to 900° C., O₂/N₂ diffusion selectivity increases by 2.3 times from 7.8 to 17.8, while O₂/N₂ sorption selectivity almost stayed constant.

Compared with polymers, CMS materials can have much higher diffusion selectivity due to intrinsic ultramicropores. However, CMS sorption selectivity is usually not attractive. Interactions between penetrant molecules and CMS surface are usually based on non-electrostatic van der Waals forces and as a result sorption affinity constants (equation 8) are almost entirely determined by penetrant molecules' polarizability. Take the CO₂/CH₄ pair for example; while polyimides can have a sorption selectivity of 3-4, CMS usually only offer a sorption selectivity of ˜2. Efforts have been made to increase sorption selectivity by adding more sorption-selective components in the CMS network; however, these components may interrupt with ultramicropore formation during pyrolysis and consequently undermine diffusion selectivity of the material. Our discoveries presented herein open an entirely new way to increase CMS membrane permselectivity by increasing sorption selectivity without compromising diffusion selectivity. Instead of attempting to modify sorption affinity constants through modifying surface chemistry, our approach improves sorption selectivity by reducing the amount of micropores (and hence available surface area for sorption) accessible to larger and slower diffusing species. It should be noted that this approach will inevitably reduce permeability of the material.

As described previously, CMS is comprised by ultramicropores and micropores, which respectively governs diffusivity and sorption coefficient of the material. For CMS pyrolyzed at 750° C., all micropores are accessible to H₂, CO₂, O₂, N₂, and CH₄ sorption. As pyrolysis temperature increases, the ultramicropores are increasingly refined, which contributes to increased diffusion selectivities. In the meantime, the ultramicropores become so refined that a portion of micropores would totally exclude sorption of some penetrant molecules and reduce their sorption coefficients. Since penetrant molecules differ in molecular size and/or shape (Table 1), the extent of such exclusion effect would differ by the penetrant molecule.

TABLE 1

| | Kinetic diameter |
|---|---|
| Penetrant | (Å) |
| H₂ | 2.89 |
| CO₂ | 3.3 |
| O₂ | 3.46 |
| N₂ | 3.64 |
| CH₄ | 3.8 |

Clearly, smaller molecules are less affected than larger molecules and consequently an increase in sorption selectivity was achieved for smaller over larger molecules. CH₄ with the largest kinetic diameter was most affected with 89% reduction in sorption coefficient (comparing CMS pyrolyzed at 750 and 900° C.). O₂ and N₂ sorption coefficients were each reduced by ˜50% and CO₂ sorption coefficient was essentially unchanged (again, comparing CMS pyrolyzed at 750 and 900° C.).

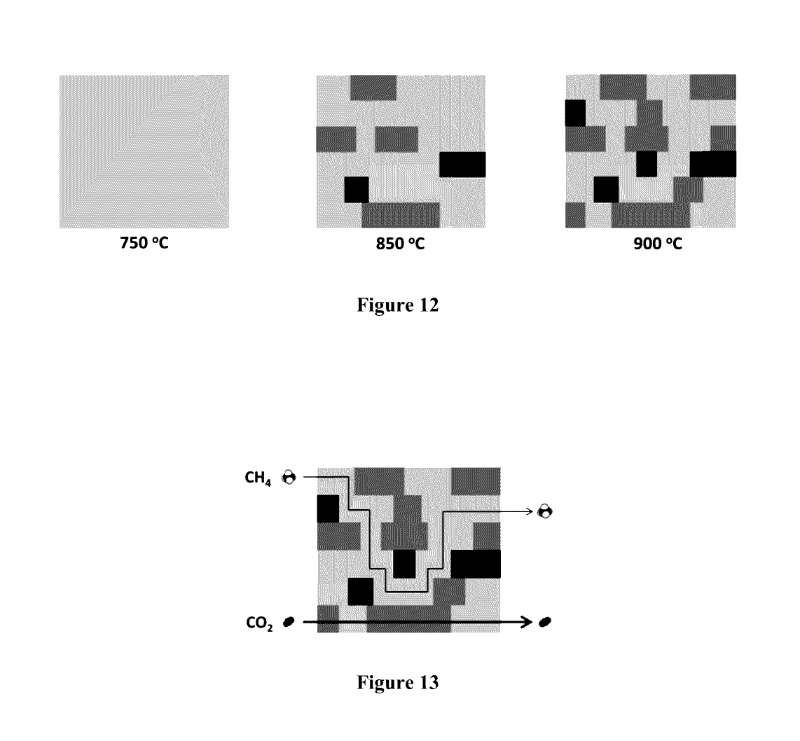

FIG. 12 demonstrates how CMS' ultramicropore and micropore structure evolve as the pyrolysis temperature increases from 750 to 900° C. The black region (defined as Phase III micropores) represents micropores that are available for H₂ and CO₂ sorption but exclude larger O₂, N₂, and CH₄. The dark grey region (defined as Phase II micropores) represents micropores that are available for H₂ CO₂, O₂, and N₂ sorption but exclude CH₄. The light region (defined as Phase I micropores) represents micropores that are available for sorption of all studied gases (H₂ CO₂, O₂, N₂, and CH₄). Clearly, Phase I micropores are most permeable but least selective, while Phase III micropores are least permeable but most selective. For CMS pyrolyzed at 750° C., all ultramicropores are sufficiently open and we hypothesize that the CMS is entirely comprised by phase I micropores. As pyrolysis temperature increases, Phase II and III micropores start to form inside the CMS porous network and their concentrations (in terms of micropore surface area) increase with increasing pyrolysis temperature, as shown in FIG. 12.

In fact, formation of Phase II and III micropores not only contributes to increased sorption selectivity, but also to increased diffusion selectivity. Molecular transport of CO₂ is not obstructed by Phase II and III micropores. On the other hand, since CH₄ molecules are excluded from both Phase II and III micropores, they have to bypass these regions in the CMS network and take a longer pathway diffusing to the downstream side of the membrane, as shown in FIG. 13. Although not shown, this same mechanism may be used to explain an increase in sorption selectivity achieved for H₂ or CO₂ (smaller) molecules over N₂ (larger) molecules, as the N₂ molecules are excluded from the Phase III micropores. This same mechanism is also expected to be applicable for other non-listed gas pairings.

Conventionally, mixed-matrix membranes are formed by dispersing molecular sieve (e.g. zeolites, MOFs/ZIFs, CMS, etc.) particles inside continuous polymer matrices. With wisely chosen sieve and matrix, gas separation performance of the membrane can be increased over the matrix, if intact sieve-matrix interface can be achieved. Presently disclosed ultra-selective CMS membranes can be considered as a new type of mixed-matrix membrane. In our newly invented CMS/CMS' mixed-matrix membrane, the “matrix” is Phase I micropores which are more permeable and less selective. On the other hand, the “sieves” are Phase II and III micropores, which are more selective but less permeable than Phase I micropores. While non-ideal adhesions may be a problem for conventional mixed-matrix membranes, such problem does not exist for CMS/CMS' mixed-matrix membrane since the matrix and the sieve are identical materials (with different transport properties, though) and no sieve-matrix interface exists.

The present disclosure describes a surprising and unexpected method to create ultra-selective CMS membranes by increasing the membrane's sorption selectivity. Increasing pyrolysis temperature from 750 to 900° C. significantly increased selectivities of Matrimid-derived CMS membranes to unprecedented levels. Analyzing permeation data indicates that sorption coefficients of larger penetrants were reduced and consequently increased sorption selectivity was achieved. The reduced sorption coefficient appears to be due to exclusion of these larger molecules from a portion of micropores as a result of overly refined ultramicropores. In fact, by creating more selective micropores inside the CMS network, we have invented a new type of membrane-namely CMS/CMS' mixed-matrix membrane.

While the example is given by dense-walled monolithic CMS hollow fiber derived from Matrimid®, we expect that our discoveries can be extended to other precursor materials and other membrane geometry for a wider spectrum of gas/vapor/liquid separation applications that are not limited to those discussed in this disclosure.

It can be seen that the described embodiments provide unique and novel CMS membranes that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A process for making a carbon molecular sieve membrane having a desired permselectivity between a first gas species and a second gas species, the second gas species having a larger kinetic diameter than the first gas species, comprising
a. providing a polymer precursor; and
b. pyrolyzing the polymer precursor at a pyrolysis temperature that is effective to selectively reduce the sorption coefficient of the second gas species, thereby increasing the permselectivity of the resulting carbon molecular sieve membrane.

2. The process of claim 1, wherein the second gas species is CH₄.

3. The process of any one of claim 2, wherein the first gas species is H₂.

4. The process of any one of claim 2, wherein the first gas species is N₂.

5. The process of any one of claim 2, wherein the first gas species is CO₂.

6. The process of claim 1, wherein the first gas species is CO₂ and the second gas species is N₂.

7. The process of claim 1, wherein the pyrolysis temperature is at least 800° C.

8. The process of claim 7, wherein the pyrolysis temperature is at least 850° C.

9. The process of claim 8, wherein the pyrolysis temperature is greater than 875° C.

10. The process of claim 9, wherein the pyrolysis temperature is greater than 900° C.

11. The process of claim 1, wherein the polymer precursor comprises a polymeric fiber or polymeric film.

12. The process of claim 11, wherein the polymer precursor comprises an asymmetric hollow polymer fiber.

13. The process of claim 1, wherein the polymer precursor comprises a polyimide.

14.-28. (canceled)

29. A process for separating at least a first gas species and a second gas species, comprising:
(a) providing a carbon molecular sieve membrane produced by the process of claim 1, and
(b) flowing a mixture of at least the first gas species and the second gas species through the membrane to produce:
(i) a retentate stream having a reduced concentration of the first gas species, and
(ii) a permeate stream having an increased concentration of the first gas species.

30. The process of claim 29, wherein the first gas species is CO₂ and the second gas species is N₂.

31. A process for separating non-hydrocarbon components from a natural gas stream comprising
(a) providing a carbon molecular sieve membrane produced by the process of claim 1, and
(b) contacting a natural gas stream with said membrane to produce
(i) a retentate stream having a reduced concentration of non-hydrocarbon components, and
(ii) a permeate stream having an increased concentration of non-hydrocarbon components.

32. The process of claim 31, wherein the non-hydrocarbon components comprise H₂, N₂, CO₂, H₂S, or mixtures thereof.

33. The carbon molecular sieve membrane produced by the process of claim 1.

34. A carbon molecular sieve module comprising a sealable enclosure, said enclosure having:
a plurality of carbon molecular sieve membranes contained therein, at least one of said carbon molecular sieve membranes produced according to the process of claim 1,
an inlet for introducing a feed stream comprising at least a first gas species and a second gas species;
a first outlet for permitting egress of a permeate gas stream; and,
a second outlet for permitting egress of a retentate gas stream.

35. A mixed-matrix carbon molecular sieve membrane having a permselectivity between a first gas species and a second gas species, the second gas species having a larger kinetic diameter than the first gas species, comprising:
a. a matrix material; and
b. a sieve material;
wherein the sieve material comprises a carbon molecular sieve material having micropores that are sized so as to exclude sorption of the second gas species; and
the matrix material comprises a carbon molecular sieve material having micropores that are sized so as to provide for sorption of the second gas species.

36. The mixed-matrix carbon molecular sieve membrane of claim 35, wherein the second gas species is CH₄.

37. The mixed-matrix carbon molecular sieve membrane of claim 35, wherein the second gas species is N₂.

38. The mixed-matrix carbon molecular sieve membrane of claim 35, wherein the mixed-matrix carbon molecular sieve membrane has substantially no sieve-matrix interface.
